(19) United States
(12) Patent Application Publication
(10) Pub. No.: US 2026/0352616 A1
(43) Pub. Date: Nov. 5, 2026

(54) METHOD FOR GENERATING EVENT-RELATED MESSAGE THROUGH IMAGE ANALYSIS AND APPARATUS FOR SUPPORTING SAME

(71) Applicant: HANWHA VISION CO., LTD., Seongnam-si (KR)

(72) Inventors: Changseup KIM, Seongnam-si (KR); Woohyun KIM, Seongnam-si (KR); Seung Hwan KIM, Seongnam-si (KR)

(73) Assignee: HANWHA VISION CO., LTD., Seongnam-si (KR)

(21) Appl. No.: 19/715,292

(22) Filed: Jun. 22, 2026

Related U.S. Application Data
(63) Continuation of application No. PCT/KR2024/000672, filed on Jan. 15, 2024.

(30) Foreign Application Priority Data
Dec. 22, 2023 (KR) 10-2023-0189345

(51) Int. Cl. H04L 51/02; G06F 40/58; G06V 10/74; G06V 10/764; G06V 20/52; H04L 51/58

(52) U.S. Cl. CPC H04L 51/02; G06F 40/58; G06V 10/74; G06V 10/764; G06V 20/52; H04L 51/58

(57) ABSTRACT

A method for generating an event-related message through image analysis includes: based on a predefined event occurring in a captured image, detecting first keywords respectively corresponding to an object, an event occurrence area, and a type of the event in the captured image at a time point of occurrence of the event; generating a first message related to the occurrence of the event based on the detected first keywords; obtaining a previous image captured before the captured image; detecting, in the obtained previous image, second keywords respectively corresponding to a capturing time of the previous image, an area related to the occurrence of the event, and a cause of the event; generating a second message related to the cause of the event based on the detected second keywords; and determining an urgency of the event and a scope of the event based on the first and second messages.

### CROSS-REFERENCE TO RELATED APPLICATION(S)

This application is a continuation of International Application No. PCT/KR2024/000672, filed on Jan. 15, 2024, in the Korean Intellectual Property Receiving Office, which is based on and claims priority to Korean Patent Application No. 10-2023-0189345, filed on Dec. 22, 2023, in the Korean Intellectual Property Office, the disclosures of which are incorporated by reference herein in their entireties.

### BACKGROUND

### 1. Field

The present disclosure relates to a method for generating an event-related message, and more particularly, to a method for generating an event-related message through image analysis and an apparatus for supporting the same.

### 2. Description of Related Art

In a related art, when an event such as an emergency situation occurs while a captured image is being monitored in a situation room or a control center, a control agent may confirm the captured image and disseminate the emergency situation or the like to a field agent or the like by utilizing a wireless radio, a mobile phone, or the like.

That is, the related method for delivering an emergency situation may have a problem in that a dissemination result varies depending on accumulated control experience or the like, such that the control agent may verbally disseminate the situation based on a current image being captured.

A related art may determine whether an accident has occurred through image analysis and transmit an accident notification message.

However, the related art may not automatically generate a message related to occurrence of an accident through image analysis.

That is, research on a method for automatically generating a message related to an event and delivering the message to an outside upon occurrence of an event such as an accident is required.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

Provided is a method for extracting a keyword related to an event through image analysis and generating an event-related message through the extracted keyword to automatically deliver the event-related message to a field agent, a police officer, a firefighter, or the like.

Further, provided is an event mark function in a memory or a storage unit of an image analysis apparatus when an urgency and a scope for an event are determined.

Additional aspects will be set forth in part in the description which follows and, in part, will be apparent from the description, or may be learned by practice of the presented embodiments.

According to an aspect of the present disclosure, a method for generating an event-related message through image analysis may include: based on a predefined event occurring in a captured image, detecting first keywords respectively corresponding to an object, an event occurrence area, and a type of the event in the captured image at a time point of occurrence of the event; generating a first message related to the occurrence of the event based on the detected first keywords; obtaining a previous image captured before the captured image; detecting, in the obtained previous image, second keywords respectively corresponding to a capturing time of the previous image, an area related to the occurrence of the event, and a cause of the event; generating a second message related to the cause of the event based on the detected second keywords; and determining an urgency of the event and a scope of the event based on the first message and the second message.

The method may further include transmitting a notification message related to the occurrence of the event based on the determined urgency of the event and the scope of the event.

The previous image may be an image that includes the object among images captured prior to the time point of the occurrence of the event of the captured image.

The generating of the first message may include: arranging the first keywords in an order of the object, the event occurrence area, and the type of the event.

The generating of the second message may include: calculating a time delta by comparing the capturing time of the previous image with the time point of the occurrence of the event of the captured image; and arranging the second keywords in an order of the calculated time delta, the area related to the occurrence of the event, and the cause of the event.

The urgency of the event may be determined based on the time delta, the cause of the event, and the object.

The urgency of the event may be classified as high, medium, or low.

The scope of the event may be determined based on the event occurrence area and the object.

The scope of the event may be classified as wide, normal, or narrow.

The first message and the second message may be generated through a Large Language Model (LLM).

The method may further include: converting language of the second keywords to correspond to a language type of the first keywords based on the language type of the first keywords and a language type of the second keywords being different.

According to an aspect of the present disclosure, an image analysis apparatus for generating an event-related message through image analysis may include: a wireless communication interface configured to transmit and receive a wireless signal; a memory storing a captured image; and at least one processor operatively connected to the wireless communication interface and the memory, where the at least one processor is configured to: based on a predefined event occurring in the captured image, detect first keywords respectively corresponding to an object, an event occurrence area, and a type of the event in the captured image at a time point of occurrence of the event, generate a first message related to the occurrence of the event based on the detected first keywords, obtain a previous image captured before the captured image, detect, in the obtained previous image, second keywords respectively corresponding to a capturing time of the previous image, an area related to the occurrence of the event, and a cause of the event, generate a second message related to the cause of the event based on the detected second keywords, and determine an urgency of the event and a scope of the event based on the first message and the second message.

The at least one processor may be further configured to: determine, as the previous image, an image that includes the object among images captured prior to the time point of the occurrence of the event of the captured image.

The at least one processor may be further configured to: generate the first message by arranging the detected first keywords in an order of the object, the event occurrence area, and the type of the event.

The at least one processor may be further configured to: calculate a time delta by comparing the capturing time of the previous image with the time point of the occurrence of the event of the captured image, and generate the second message by arranging the second keywords in an order of the calculated time delta, the area related to the occurrence of the event, and the cause of the event.

The obtaining the previous image may include: filtering images that are captured prior to the time point of the occurrence of the event; and among the filtered images, determining, as the previous image, an image that includes the object and the event occurrence area among the first keywords.

The obtaining the previous image may further include: based on not being able to determine the previous image by filtering the images that are captured prior to the time point of the occurrence of the event and determining the image that includes the object and the event occurrence area, determining, as the previous image, an image from which the cause of the event among the second keywords constituting the second message is extractable.

The obtaining the previous image may include: filtering images that include the object; and among the filtered images, determining the previous image using the time point of the occurrence of the event and the event occurrence area among the first keywords.

The obtaining the previous image may further include: based on not being able to determine the previous image by filtering the images that include the object and determining the previous image using the time point of the occurrence of the event and the event occurrence area, determining, as the previous image, an image from which the cause of the event among the second keywords constituting the second message is extractable.

According to an aspect of the present disclosure, a non-transitory recording medium may store a computer program, which, when executed by at least one processor of an image analysis apparatus, causes the image analysis apparatus to execute a method including: based on a predefined event occurring in a captured image, detecting first keywords respectively corresponding to an object, an event occurrence area, and a type of the event in the captured image at a time point of occurrence of the event; generating a first message related to the occurrence of the event based on the detected first keywords; obtaining a previous image captured before the captured image; detecting, in the obtained previous image, second keywords respectively corresponding to a capturing time of the previous image, an area related to the occurrence of the event, and a cause of the event; generating a second message related to the cause of the event based on the detected second keywords; and determining an urgency of the event and a scope of the event based on the first message and the second message.

The above-described summary is provided to introduce example aspects of the disclosure in a simplified format. This summary is neither intended to identify key or essential aspects of the disclosure, nor is it intended to determine the scope of the disclosure.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating an example of a conceptual diagram of an image monitoring system, according to an embodiment of the present disclosure;

FIG. 2 is an internal block diagram for describing an image analysis apparatus, according to an embodiment of the present disclosure;

FIG. 3 is a block diagram of an artificial intelligence (AI) apparatus, according to an embodiment of the present disclosure

FIG. 4 is a diagram illustrating an example of a method for generating a message, according to an embodiment of the present disclosure;

FIG. 5 is a flowchart illustrating an example of a method for generating a message through image analysis, according to an embodiment of the present disclosure; and

FIG. 6 is a flowchart illustrating another example of a method for generating a message through image analysis, according to an embodiment of the present disclosure.

### DETAILED DESCRIPTION

It should be noted that the technical terms used in the present disclosure are merely used to describe specific embodiments and are not intended to limit the spirit of the technology disclosed in the present disclosure. Further, unless specifically defined otherwise in the present disclosure, the technical terms used in the present disclosure should be construed as having meanings generally understood by those of ordinary skill in the art to which the technology disclosed in the present disclosure pertains, and should not be construed as having an excessively comprehensive meaning or as having an excessively narrow meaning. Further, when a technical term used in the present disclosure is an erroneous technical term that does not accurately express the spirit of the technology disclosed in the present disclosure, it should be understood as being replaced with a technical term that can be correctly understood by those of ordinary skill in the art to which the technology disclosed in the present disclosure pertains. Further, the general terms used in the present disclosure should be construed according to definitions in dictionaries or according to context, and should not be construed as having an excessively narrow meaning.

Terms including ordinals such as first, second, and the like used in the present disclosure may be used to describe various components, but the components should not be limited by the terms. The terms are used only for the purpose of distinguishing one component from another component. For example, without departing from the scope of the rights of the disclosure, a first component may be named a second component, and similarly, a second component may also be named a first component.

Hereinafter, embodiments disclosed in the present disclosure will be described in detail with reference to the accompanying drawings, wherein the same or similar components are given the same reference numerals regardless of the drawing reference numerals, and redundant descriptions thereof will be omitted. The embodiments described herein are non-limiting example embodiments, and thus, the disclosure is not limited thereto and may be realized in various other forms. One or more features of at least one embodiment provided herein may be applied to one or more other embodiments provided herein or not provided but consistent with the disclosure. Also, at least one embodiment provided herein is not excluded from being associated with one or more features of another example or another embodiment also provided herein or not provided herein but consistent with the disclosure.

Further, in describing the technology disclosed in the present disclosure, when it is determined that a detailed description of a related known technology may obscure the gist of the technology disclosed in the present disclosure, the detailed description thereof will be omitted. Further, it should be noted that the accompanying drawings are only intended to allow the spirit of the technology disclosed in the present disclosure to be easily understood, and should not be construed as limiting the spirit of the technology by the accompanying drawings.

An image according to an embodiment of the present disclosure includes both a still image and a moving image, unless there is a particular limitation.

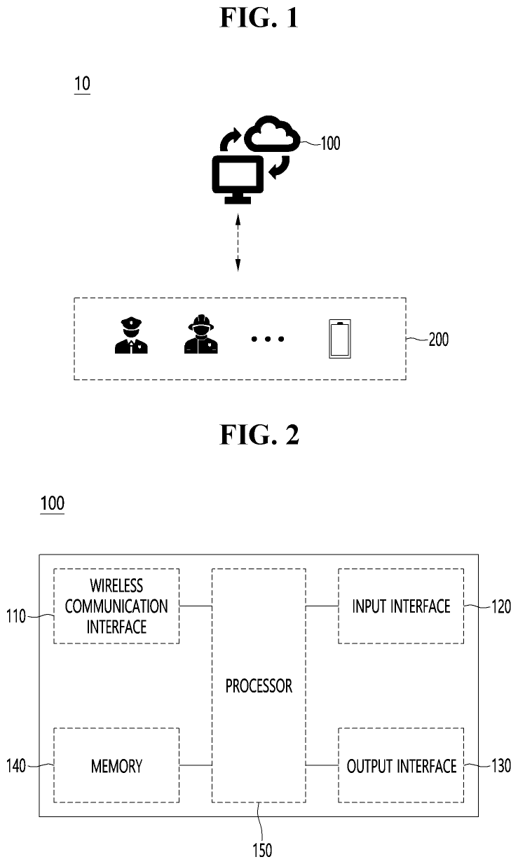

FIG. 1 is a diagram illustrating an example of a conceptual diagram of an image monitoring system according to an embodiment of the present disclosure.

Referring to FIG. 1, an image monitoring system 10 may include an image analysis apparatus 100, a terminal apparatus 200, and the like.

The image analysis apparatus 100 may be an apparatus capable of implementing a method for automatically generating an event-occurrence-related message through artificial intelligence (AI) analysis of a captured image according to an embodiment of the present disclosure, and may include cameras such as a surveillance camera (or CCTV), an edge device, an AI camera, and a network camera, storage devices such as an NVR, a server, and the like.

The terminal apparatus 200 may be an apparatus capable of receiving an event occurrence notification message, and may include a terminal carried by a field agent, a terminal related to the police (e.g., a terminal carried by a police officer, a terminal installed inside a police car, a terminal of a police station, or the like), a terminal related to a fire department (e.g., a terminal carried by a firefighter, a terminal installed inside a fire engine, a terminal of a fire station, or the like), and the like.

### Internal Block Diagram of Image Analysis Apparatus

FIG. 2 is an internal block diagram for describing the image analysis apparatus according to an embodiment of the present disclosure.

The image analysis apparatus 100 may include a wireless communication interface 110, an input interface 120, an output interface 130, a memory 140, a processor 150, and the like. The components illustrated in FIG. 2 are not essential in implementing the image analysis apparatus, and thus the image analysis apparatus described in the present disclosure may have more or fewer components than the components listed above.

According to an embodiment, the wireless communication interface 110 may include one or more modules that enable wireless communication between the image analysis apparatus 100 and the image monitoring system 10 and between the image analysis apparatus 100 and the terminal apparatus 200. Further, the wireless communication interface 110 may include one or more modules that connect the image analysis apparatus 100 to one or more networks.

Such a wireless communication interface 110 may include at least one of a mobile communication module, a short-range communication module, and a location information module. The wireless communication interface 110 may include any one or any combination of a digital modem, a radio frequency (RF) modem, an antenna circuit, a WiFi chip, and related software and/or firmware.

The input interface 120 may include a user input unit (for example, a touch key, a mechanical key, or the like) for receiving information from a user. The input interface 120 may additionally include a camera or an image input unit for inputting an image signal, a microphone for inputting an audio signal, an audio input unit, or the like. Voice data or image data collected by the input interface 120 may be analyzed and processed as a control command of the user.

The output interface 130 may be for generating an output related to vision, hearing, touch, or the like, and may include a display, a sound output unit such as one or more speakers, and the like.

Further, the memory 140 may store data that supports various functions of the image analysis apparatus. The memory 140 may store a plurality of application programs (or applications) driven by the image analysis apparatus 100, data for an operation of the image analysis apparatus 100, and instructions. At least some of these application programs may be downloaded from an external server through wireless communication. Meanwhile, the application program may be stored in the memory 140, installed on the image analysis apparatus 100, and driven by the processor 150 to perform an operation (or function) of the image analysis apparatus 100.

The processor 150, in addition to operations related to the application programs, may control overall operations of the image analysis apparatus 100. The processor 150 may process signals, data, information, and the like input or output through the components described above, or may drive the application programs stored in the memory 140, thereby providing or processing information or functions appropriate for a user. The processor 150 may also be referred to as a controller, and may be physically implemented by analog and/or digital circuits including one or more of a logic gate, an integrated circuit, a microprocessor, a microcontroller, a memory circuit, a passive electronic component, an active electronic component, an optical component, and the like, and may implement or execute software and/or firmware to perform the functions or operations described herein.

Further, in order to drive the application programs stored in the memory 140, the processor 150 may control at least some of the components described together with FIG. 2. Furthermore, in order to drive the application programs, the processor 150 may operate at least two or more of the components included in the image analysis apparatus 100 in combination with each other.

According to an embodiment, when a predefined event occurs in a captured image, the processor 150 may detect first keywords respectively corresponding to an object, an event occurrence area, and a type of the event in a current image at a time point of occurrence of the event, generate a first message related to an initial occurrence of the event based on the detected first keywords, obtain a previous image with respect to the current image, detect, in the obtained previous image, second keywords respectively corresponding to a capturing time of the previous image, an area related to occurrence of the event, and a cause of the event, generate a second message related to the cause of occurrence of the event based on the detected second keywords, and determine an urgency of the event and a scope of occurrence of the event based on the first message and the second message.

According to an embodiment, the processor 150 may determine, as the previous image, an image including the object among images prior to the time point of occurrence of the event related to the current image.

According to an embodiment, the processor 150 may generate the first message by arranging the detected first keywords in an order of the object, the event occurrence area, and the type of the event.

According to an embodiment, the processor 150 may calculate a time delta by comparing the capturing time of the previous image detected as the second keyword with the capturing time of the current image, and may generate the second message by arranging the second keywords in an order of the calculated time delta, the area related to the occurrence of the event, and the cause of the event.

At least some of the respective components may operate in cooperation with each other to implement an operation, a control, or a control method of the image analysis apparatus 100 according to various embodiments described below. Further, the operation, the control, or the control method of the image analysis apparatus 100 may be implemented on the image analysis apparatus 100 by driving at least one application program stored in the memory 140.

### Block Diagram of AI Apparatus

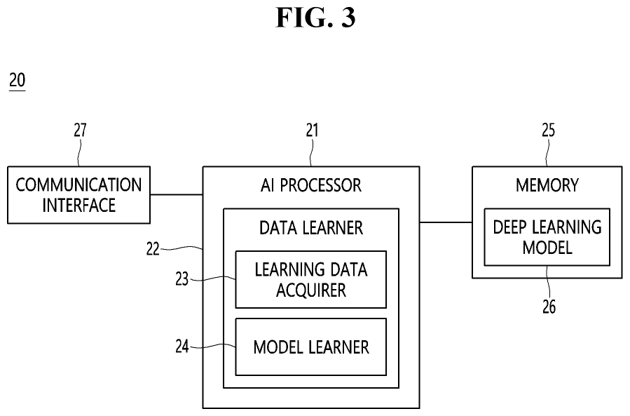

FIG. 3 is a block diagram of the AI apparatus according to an embodiment of the present disclosure.

The AI apparatus 20 may be included as at least a part of the configuration of the image analysis apparatus 100 illustrated in FIG. 1 or FIG. 2 and provided so as to perform at least a part of AI processing together.

The AI apparatus 20 may include an AI processor 21, a memory 25, and/or a communication interface 27. According to an embodiment in which the AI apparatus 20 is included in the image analysis apparatus 100, the communication interface 27 may be omitted.

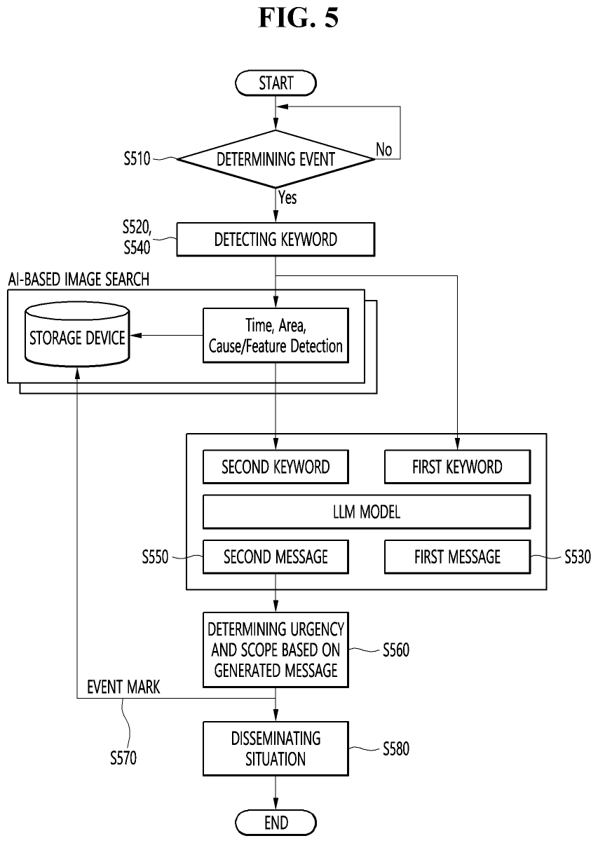

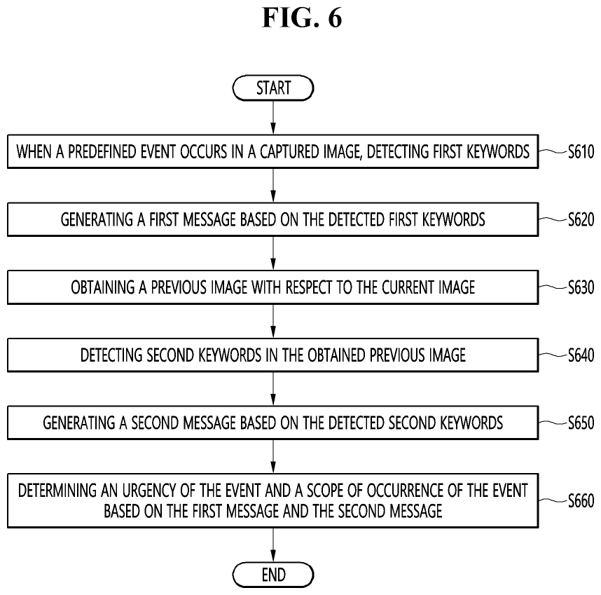

The AI apparatus 20 may be a computing apparatus capable of learning a neural network, may be implemented as various electronic apparatuses such as a server, a desktop PC, a notebook PC, and a tablet PC, and may be equipped with the LLM model described in FIG. 5 to FIG. 6 to perform the method proposed in the present disclosure.

The AI processor 21 may learn a neural network using a program stored in the memory 25. For example, the AI processor 21 may learn a neural network for recognizing image-related data. Here, the neural network for recognizing image-related data may be designed to simulate a human brain structure on a computer, and may include a plurality of weighted network nodes that simulate neurons of a human neural network. The plurality of network nodes may transmit and receive data according to respective connection relationships so as to simulate synaptic activity of the neurons in which the neurons transmit and receive signals through synapses. Here, the neural network may include a deep learning model that has evolved from a neural network model. In the deep learning model, the plurality of network nodes may be located in different layers and may transmit and receive data according to a convolution connection relationship. Examples of the neural network model include various deep learning techniques such as deep neural networks (DNN), convolutional deep neural networks (CNN), recurrent neural networks (RNN, Recurrent Boltzmann Machine), Restricted Boltzmann Machine (RBM), deep belief networks (DBN), and Deep Q-Network, and may be applied to fields such as computer vision, voice recognition, natural language processing, and voice/signal processing.

Meanwhile, the AI processor 21 performing the functions as described above may be a general-purpose processor (for example, a CPU), but may also be an AI-dedicated processor (for example, a GPU) for artificial intelligence learning.

The memory 25 may store various programs and data necessary for an operation of the AI apparatus 20. The memory 25 may be implemented as one or more of a non-volatile memory, a volatile memory, a flash memory, a hard disk drive (HDD), a solid state drive (SDD), or the like. The memory 25 may be accessed by the AI processor 21, and reading/writing/modifying/deleting/updating of data by the AI processor 21 may be performed. Further, the memory 25 may store a neural network model (for example, a deep learning model 26 and a Re-ID model 28) generated through a learning algorithm for image analysis according to an embodiment of the present disclosure.

Meanwhile, the AI processor 21 may include a data learner 22 that learns a neural network for image analysis. The data learner 22 may learn criteria regarding which learning data to use to determine image analysis and how to classify and recognize data using the learning data. The data learner 22 may acquire learning data to be used for learning and may learn the deep learning model by applying the acquired learning data to the deep learning model.

The data learner 22 may be manufactured in the form of at least one hardware chip and mounted on the AI apparatus 20. For example, the data learner 22 may be manufactured in the form of a dedicated hardware chip for artificial intelligence (AI), or may be manufactured as a part of a general-purpose processor (CPU) or a graphics-dedicated processor (GPU) and mounted on the AI apparatus 20. Further, the data learner 22 may be implemented as a software module. When implemented as a software module (or a program module including instructions), the software module may be stored in a non-transitory computer readable medium. In this case, the at least one software module may be provided by an Operating System (OS) or may be provided by an application.

The data learner 22 may include a learning data acquirer 23 and a model learner 24.

The learning data acquirer 23 may acquire learning data necessary for a neural network model for image analysis. For example, the learning data acquirer 23 may acquire, as the learning data, image data and/or sample data to be input to the neural network model.

The model learner 24 may use the acquired learning data to perform learning so that the neural network model has a determination criterion regarding how to classify predetermined data. In this case, the model learner 24 may train the neural network model through supervised learning that uses at least a part of the learning data as a determination criterion. According to an embodiment, the model learner 24 may train the neural network model through unsupervised learning that discovers a determination criterion by self-learning using the learning data without supervision. Further, the model learner 24 may train the neural network model through reinforcement learning using feedback on whether a result of situation determination according to learning is correct. Further, the model learner 24 may train the neural network model using a learning algorithm including error back-propagation or gradient descent.

When the neural network model is trained, the model learner 24 may store the trained neural network model in the memory. The model learner 24 may also store the trained neural network model in a memory of a server connected to the AI apparatus 20 through a wired or wireless network.

The data learner 22 may further include a learning data preprocessor and a learning data selector to improve an analysis result of the recognition model or to save resources or time necessary for generation of the recognition model.

The learning data preprocessor may preprocess acquired data such that the acquired data can be used for learning for situation determination. For example, the learning data preprocessor may process the acquired data into a preset format so that the model learner 24 can use the acquired learning data for learning for image recognition.

Further, the learning data selector may select data necessary for learning from among the learning data acquired by the learning data acquirer 23 or the learning data preprocessed by the preprocessor. The selected learning data may be provided to the model learner 24. For example, the learning data selector may select, as the learning data, only data on an object included in a specific area by detecting the specific area from an image acquired through a camera.

Further, the data learner 22 may further include a model evaluator to improve an analysis result of the neural network model.

The model evaluator may input evaluation data to the neural network model and, when an analysis result output from the evaluation data does not satisfy a predetermined criterion, may cause the model learner 22 to perform learning again. In this case, the evaluation data may be predefined data for evaluating the recognition model. As an example, when, among analysis results of the trained recognition model with respect to the evaluation data, a number or a ratio of pieces of evaluation data for which the analysis result is not accurate exceeds a preset threshold, the model evaluator may evaluate that the predetermined criterion is not satisfied.

The communication interface 27 may transmit a result of AI processing by the AI processor 21 to an external device.

Although the AI apparatus 20 illustrated in FIG. 3 has been described as being functionally divided into the AI processor 21, the memory 25, the communication interface 27, and the like, the present disclosure is not limited thereto. For example, it is noted that the foregoing components may be integrated into one module and referred to as an AI module.

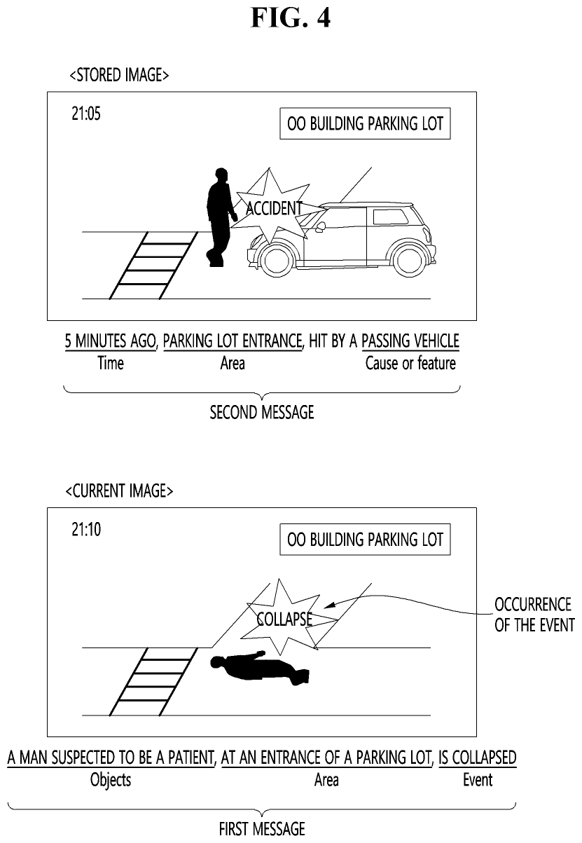

Next, a method for automatically generating an event-occurrence-related message through AI analysis of a captured image according to an embodiment of the present disclosure will be examined with reference to FIG. 4 to FIG. 5.

FIG. 4 is a diagram illustrating an example of the method for generating a message according to an embodiment of the present disclosure, and FIG. 5 is a flowchart illustrating an example of the method for generating a message through image analysis according to an embodiment of the present disclosure.

First, the image analysis apparatus may determine whether an event (or a specific event) has occurred in an image currently being captured (hereinafter referred to as a “current image”) (S510).

The event may be a predefined event; for example, the event may be an incident related to a human behavior, such as a person's loitering, intrusion into a specific place, abandonment in which an object or item is discarded, a fight between persons, arson, or a person collapsing; or may be an incident related to a disaster, such as a fire, a collapse, an explosion, a traffic accident, a chemical/biological/radiological (CBR) accident, or an environmental pollution accident; or may be an incident related to a calamity, such as a typhoon, a flood, a heavy rain, a heavy snowfall, a storm, a drought, a tsunami, or an earthquake.

Next, when occurrence of the event is detected, the image analysis apparatus may analyze the current image to extract a first keyword related to the event (S520).

The first keyword may include an object, an event type, an event occurrence area, a current time at which the event has occurred, and the like. For example, the first keyword may be any keywords associated with the detected event that may be able to characterize the detected event.

The object may be extracted from the current image using an object detection algorithm, and an object to be included in the first keyword may include a person; if there is no person, the object may be an object associated with the event that has occurred, such as a weapon, a sack, or a bag. According to an embodiment, the object may include, together with a person, an object associated with the event, such as the weapon, sack, or bag mentioned above; however, whether to include the object associated with the event may be optional.

Further, the type of the event may be an incident that has occurred in the current image, and may refer to a form, a type, or the like of the event that has caused the first keyword to be extracted.

Further, the current time at which the event has occurred may refer to a time when the event has occurred, that is, a time at which the current image was captured.

Further, the event occurrence area may be predefined as a place, a region, a space, or the like at which the event has occurred.

Next, the image analysis apparatus may generate an event initial message (or a first message) composed of the extracted first keyword (S530). The first message may refer to a message that is first generated by the image analysis apparatus through detection of the first keyword when the event occurs.

According to an embodiment, the image analysis apparatus may generate the first message by sequentially arranging the extracted first keyword in an order of the object, the area, and the type of the event, and the arrangement of the first keyword constituting the first message may be implemented through an LLM (Large Language Model) model.

For example, as illustrated in FIG. 4, when the object of the first keyword is extracted as “a man suspected to be a patient,” the area of the first keyword is extracted as “an entrance of a parking lot,” and the event type of the first keyword is extracted as “collapse,” the image analysis apparatus may generate the first message of “a man suspected to be a patient is collapsed at an entrance of a parking lot” using the LLM model in the order of the object, the area, and the type of the event.

According to an embodiment, the image analysis apparatus may tailor the structure of the first message according to a predetermined language. According to an embodiment, the image analysis apparatus may tailor the structure of the first message according to a detected language of the first keyword. For example, when the extracted first keyword is in Korean, the image analysis apparatus may combine and/or process the extracted first keyword to conform to standard Korean grammar to generate the first message; or when the extracted first keyword is in English, the image analysis apparatus may combine and/or process the extracted first keyword to conform to standard English grammar to generate the first message.

That is, the image analysis apparatus may arrange the keyword in conformity with the arrangement order of the extracted first keyword, and may generate the first message such that the arranged keyword conforms to standard grammar corresponding to a language type of the extracted keyword by identifying the language type of the extracted keyword.

In order to generate the first message in conformity with the standard grammar according to the language type, the image analysis apparatus may store standard grammar for each language in advance in the memory of the image analysis apparatus.

Next, the image analysis apparatus may generate an event additional message (or a second message) based on the generated first message.

For example, the image analysis apparatus may search the memory or a storage device for a previous image related to the current image and extract (or finds, obtains, or acquires) the previous image.

Here, the image analysis apparatus may obtain the previous image related to the current image from the memory or the storage device based on the following criteria.

First, (1) the apparatus may filter images prior to the time of the current image by a predetermined time, and determine, as the previous image, an image including an “object” and/or an “area” among the first keyword from among the primarily filtered images; or (2) the apparatus may filter images including an “object” among the first keyword, and when the primarily filtered images exist in a predetermined number or more, determine the previous image in consideration of an “area” and/or a “time” among the first keyword.

According to an embodiment, when the “time” of the first keyword is considered, only images within a predetermined time from the time of the current image (for example, 30 minutes ago, 1 hour ago, 4 hours ago, 24 hours ago, or the like) may be considered.

Further, when the image analysis apparatus cannot determine or specify the previous image even through both of the two methods for determining the previous image examined above, the image analysis apparatus may determine, as the previous image, an image from which a “cause or feature of the event” among second keywords constituting a second message to be described later can be extracted, from among the images filtered by the method of (1) or (2).

The image analysis apparatus may extract a second keyword from the determined previous image (S540).

The second keyword may include a cause of the event or a feature of the event, a time at which the previous image was captured (hereinafter referred to as a “previous time”), an area, and the like.

The image analysis apparatus may generate the second message including the extracted second keyword (S550).

According to an embodiment, before generating the second message through the extracted second keyword, the image analysis apparatus may first calculate a “time delta (or delta).”

The time delta may refer to a time corresponding to a difference between the time at which the current image was captured and the previous time. For example, when the time at which the current image was captured is 21:10 and the previous time is 21:05, the time delta may correspond to 5 minutes.

Further, the image analysis apparatus may sequentially arrange in an order of the calculated time delta, the area, and the cause of the event (or the feature of the event), and apply the LLM model to generate the second message.

Here, the second message may be generated to conform to standard grammar corresponding to a language type of the second keyword applied at the time of generating the first message described above.

For example, when a time difference of the second keyword is “5 minutes ago,” the area is “an entrance of a parking lot,” and the cause of the event is “hit by a passing vehicle,” the second message may be generated as the second message of “hit by a vehicle passing through the entrance of the parking lot 5 minutes ago.”

Here, the language type of the first message and the language type of the second message may be the same; however, when the language type of the first message and the language type of the second message are different, the image analysis apparatus may translate or convert the language type of the second message to match the language type of the first message.

Next, the image analysis apparatus may determine an urgency of the event and a scope of the event with respect to the event that has occurred, based on the generated first message and the second message (S560).

Here, the urgency of the event may be a parameter that determines a dissemination scope to a manager, a control agent, a police station, a fire station, or the like according to the type of the event, and may be classified as high, medium, or low.

The urgency of the event may be determined by using the time delta, the cause of the event, and the object in the first keyword or the second keyword as determination factors of the urgency.

That is, the urgency of the event may be classified as high, medium, or low by using, as determination factors, an occurrence process of the event, an impact degree of the event, a damage possibility caused by the event, a predictability of the event, a situation turning point of the event, a controllability of the event, a persistence of the event, and the like.

Further, the scope of the event may be a factor that determines a damage location, a damage size, a damage height, and the like according to the occurrence of the event. According to an embodiment, the scope of the event may be determined as wide, normal, or narrow, and may be determined by using the area, the objects, and the like in the first keyword or the second keyword as determination factors. According to an embodiment, the scope of the event may be determined by using the same situational exposure level in association with surrounding surveillance cameras such as CCTVs.

Next, the image analysis apparatus may transmit (e.g., disseminate) a notification message related to the occurrence of the event to an outside according to the determined urgency and scope of the event (S580).

Further, the image analysis apparatus may record or display a mark on a corresponding event according to the determined urgency and scope of the event (S570) and may store the mark in the memory or the storage device, thereby enabling extraction of a keyword from the image and more accurate generation of an event-related message through the extracted keyword.

The outside may be a terminal of a field agent, a police station, a fire station, or the like.

FIG. 6 is a flowchart illustrating another example of the method for generating a message through image analysis according to an embodiment of the present disclosure.

First, when a predefined event occurs in a captured image, the image analysis apparatus may detect first keywords respectively corresponding to an object, an event occurrence area, and a type of the event in a current image at a time point of occurrence of the event (S610).

Next, the image analysis apparatus may generate a first message related to an initial occurrence of the event based on the detected first keywords (S620).

The first message may be generated by arranging the first keywords in an order of the object, the event occurrence area, and the type of the event.

Next, the image analysis apparatus may obtain a previous image with respect to the current image (S630).

Here, the previous image may be an image including the object among images prior to the time point of occurrence of the event related to the current image.

Next, the image analysis apparatus may detect, in the obtained previous image, second keywords respectively corresponding to a capturing time of the previous image, an area related to occurrence of the event, and a cause of the event (S640).

Next, the image analysis apparatus may generate a second message related to the cause of occurrence of the event based on the detected second keywords (S650).

The second message may be generated by calculating a time delta by comparing the capturing time of the previous image detected as the second keyword with the capturing time of the current image, and arranging the second keywords in an order of the calculated time delta, the area related to the occurrence of the event, and the cause of the event.

Next, the image analysis apparatus may determine an urgency of the event and a scope of occurrence of the event based on the first message and the second message (S660).

The urgency of the event may be determined based on the time delta, the cause of the event, and the object.

The urgency of the event may be classified as high, medium, or low.

The scope of the event may be determined based on the event occurrence area and the object.

The scope of the event may be classified as wide, normal, or narrow.

Additionally, the image analysis apparatus may transmit a notification message related to the occurrence of the event based on the determined urgency of the event and the scope of occurrence of the event.

Further, the first message and the second message may be generated through a Large Language Model (LLM).

Further, when a language type of the first keyword and a language type of the second keyword are different, the image analysis apparatus may convert the language of the second keyword to be identical to the language type of the first keyword.

At least one embodiment of the present disclosure, by extracting a keyword related to an event through image analysis and automatically generating and delivering an event-related message through the extracted keyword, may have effects of being capable of delivering the same event occurrence situation regardless of differences in experience of a control agent or the like, and may be capable of notifying a place or a person related to the event, such as a field agent, a police officer, or a firefighter, of the fact of the occurrence of the event simultaneously and rapidly.

The effects obtainable in the present disclosure are not limited to the effects mentioned above, and other effects not mentioned will be clearly understood, by those of ordinary skill in the art to which the present disclosure pertains, from the foregoing description.

The embodiments described above are those in which the components and features of the present disclosure are combined in a predetermined form. Each component or feature should be considered as optional unless explicitly mentioned otherwise. Each component or feature may be implemented in a form not combined with other components or features. Further, it is also possible to constitute an embodiment of the present disclosure by combining some components and/or features. An order of the operations described in the embodiments of the present disclosure may be changed. Some configurations or features of one embodiment may be included in another embodiment, or may be replaced with corresponding configurations or features of another embodiment. Some embodiments may be constituted by combining claims that do not have an explicit citation relationship in the patent claims, or that such claims may be included as new claims by amendment after filing.

The embodiments according to the present disclosure may be implemented by various means, for example, hardware, firmware, software, or a combination thereof. In the case of implementation by hardware, an embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case of implementation by firmware or software, an embodiment of the present disclosure may be implemented in the form of a module, a procedure, a function, or the like that performs the functions or operations described above. Software code may be stored in a memory and driven by a processor. The memory may be located inside or outside the processor and may exchange data with the processor by various means already known.

The present disclosure may be embodied in other specific forms without departing from essential features of the present disclosure. Accordingly, the foregoing detailed description should not be construed as restrictive in all respects and should be considered as illustrative.

A method for generating an event-related message through image analysis of the present disclosure has been described focusing on an example applied to a surveillance system; however, it can also be applied to various other image systems. The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A method for generating an event-related message through image analysis, the method comprising:
based on a predefined event occurring in a captured image, detecting first keywords respectively corresponding to an object, an event occurrence area, and a type of the event in the captured image at a time point of occurrence of the event;
generating a first message related to the occurrence of the event based on the detected first keywords;
obtaining a previous image captured before the captured image;
detecting, in the obtained previous image, second keywords respectively corresponding to a capturing time of the previous image, an area related to the occurrence of the event, and a cause of the event;
generating a second message related to the cause of the event based on the detected second keywords; and
determining an urgency of the event and a scope of the event based on the first message and the second message.

2. The method of claim 1, further comprising:
transmitting a notification message related to the occurrence of the event based on the determined urgency of the event and the scope of the event.

3. The method of claim 1, wherein the previous image is an image that includes the object among images captured prior to the time point of the occurrence of the event of the captured image.

4. The method of claim 3, wherein the generating of the first message comprises:
arranging the first keywords in an order of the object, the event occurrence area, and the type of the event.

5. The method of claim 4, wherein the generating of the second message comprises:
calculating a time delta by comparing the capturing time of the previous image with the time point of the occurrence of the event of the captured image; and
arranging the second keywords in an order of the calculated time delta, the area related to the occurrence of the event, and the cause of the event.

6. The method of claim 5, wherein the urgency of the event is determined based on the time delta, the cause of the event, and the object.

7. The method of claim 6, wherein the urgency of the event is classified as high, medium, or low.

8. The method of claim 7, wherein the scope of the event is determined based on the event occurrence area and the object.

9. The method of claim 8, wherein the scope of the event is classified as wide, normal, or narrow.

10. The method of claim 9, wherein the first message and the second message are generated through a Large Language Model (LLM).

11. The method of claim 10, further comprising:
converting language of the second keywords to correspond to a language type of the first keywords based on the language type of the first keywords and a language type of the second keywords being different.

12. An image analysis apparatus for generating an event-related message through image analysis, the apparatus comprising:
a wireless communication interface configured to transmit and receive a wireless signal;
a memory storing a captured image; and
at least one processor operatively connected to the wireless communication interface and the memory,
wherein the at least one processor is configured to:
based on a predefined event occurring in the captured image, detect first keywords respectively corresponding to an object, an event occurrence area, and a type of the event in the captured image at a time point of occurrence of the event,
generate a first message related to the occurrence of the event based on the detected first keywords,
obtain a previous image captured before the captured image,
detect, in the obtained previous image, second keywords respectively corresponding to a capturing time of the previous image, an area related to the occurrence of the event, and a cause of the event,
generate a second message related to the cause of the event based on the detected second keywords, and
determine an urgency of the event and a scope of the event based on the first message and the second message.

13. The image analysis apparatus of claim 12, wherein the at least one processor is further configured to:
determine, as the previous image, an image that includes the object among images captured prior to the time point of the occurrence of the event of the captured image.

14. The image analysis apparatus of claim 12, wherein the at least one processor is further configured to:
generate the first message by arranging the detected first keywords in an order of the object, the event occurrence area, and the type of the event.

15. The image analysis apparatus of claim 12, wherein the at least one processor is further configured to:
calculate a time delta by comparing the capturing time of the previous image with the time point of the occurrence of the event of the captured image, and
generate the second message by arranging the second keywords in an order of the calculated time delta, the area related to the occurrence of the event, and the cause of the event.

16. The method of claim 1, wherein the obtaining the previous image comprises:
filtering images that are captured prior to the time point of the occurrence of the event; and
among the filtered images, determining, as the previous image, an image that includes the object and the event occurrence area among the first keywords.

17. The method of claim 16, wherein the obtaining the previous image further comprises:
based on not being able to determine the previous image by filtering the images that are captured prior to the time point of the occurrence of the event and determining the image that includes the object and the event occurrence area, determining, as the previous image, an image from which the cause of the event among the second keywords constituting the second message is extractable.

18. The method of claim 1, wherein the obtaining the previous image comprises:
filtering images that include the object; and
among the filtered images, determining the previous image using the time point of the occurrence of the event and the event occurrence area among the first keywords.

19. The method of claim 18, wherein the obtaining the previous image further comprises:
based on not being able to determine the previous image by filtering the images that include the object and determining the previous image using the time point of the occurrence of the event and the event occurrence area, determining, as the previous image, an image from which the cause of the event among the second keywords constituting the second message is extractable.

20. A non-transitory recording medium storing a computer program, which, when executed by at least one processor of an image analysis apparatus, causes the image analysis apparatus to execute a method comprising:
based on a predefined event occurring in a captured image, detecting first keywords respectively corresponding to an object, an event occurrence area, and a type of the event in the captured image at a time point of occurrence of the event;
generating a first message related to the occurrence of the event based on the detected first keywords;
obtaining a previous image captured before the captured image;
detecting, in the obtained previous image, second keywords respectively corresponding to a capturing time of the previous image, an area related to the occurrence of the event, and a cause of the event;
generating a second message related to the cause of the event based on the detected second keywords; and
determining an urgency of the event and a scope of the event based on the first message and the second message.
